(19) United States
(12) Patent Application Publication
(10) Pub. No.: US 2025/0370158 A1
(43) Pub. Date: Dec. 4, 2025

(54) Accurate Data Logging in a Cable Locating Instrument

(71) Applicant: Metrotech Corporation, Santa Clara, CA (US)

(72) Inventors: WILLIAM MOORE, Umberleigh (GB); JOHN MARK ROYLE, Exeter (GB)

(21) Appl. No.: 19/225,787

(22) Filed: Jun. 2, 2025

Related U.S. Application Data
(60) Provisional application No. 63/656,056, filed on Jun. 4, 2024.

(51) Int. Cl. G01V 3/08; G01V 3/165

(52) U.S. Cl. CPC G01V 3/081; G01V 3/165

(57) ABSTRACT

According to some embodiments, a cable locating instrument automatically senses the characteristic behavior associated with tracing the position of a utility such as a buried pipe or cable. Various measurements and derivations are amalgamated into a single trigger event which causes the instrument to create a logging data record. In accordance with some embodiments of this disclosure, a method of operating a line locator system includes processing signals from each antenna in an array of antennas, the antennas includes a set of three orthogonal antennas forming a top sensor and a set of three orthogonal antennas forming a bottom sensor, to determine magnitude and phase of each of the signals from each antenna; activating a log trigger based on the magnitude and phase; and logging locate data when the log trigger is activated.

### RELATED APPLICATIONS

This disclosure claims priority to U.S. Provisional Application 63/656,056, filed on Jun. 4, 2024, which is herein incorporated by reference in its entirety.

### TECHNICAL FIELD

Embodiments of the present invention are related to underground line location and, in particular, to automatic accurate data logging in a cable locating instrument.

### DISCUSSION OF RELATED ART

The process of locating buried utilities (pipes and cables) using low frequency signals is well known and widely adopted as a work practice. Line locating instruments typically include an array of spaced antennas that receive time-varying magnetic field signals generated by the underground utility itself. Such signals can be the result of currents coupled into the underground utility by a separate transmitter or are inherent in the underground utility, for example from power lines. The array of spaced antennas receives the magnetic fields, which are often at specific frequencies. Processing electronics in the line locating instrument determines the relative utility position from the line locating system, including depth, signal currents and other information. Horizontal position and depth of the underground utility, for example, can then be displayed to the user and, in some systems, recorded relative to the position of the line locator.

Recent developments in the Utility Industries have placed significant emphasis on logging data. Consequently, there is a need to develop systems for methods for automatic accurate logging in a cable locating instrument.

### SUMMARY

According to some embodiments, an underground line locator system is presented. In accordance with embodiments of the present disclosure, an underground line locator system includes a spatial array of antennas, the spatial array of antennas detecting an alternating magnetic field emanating from a buried conductor coupled to a transmitter, the spatial array of antennas forming a top sensor of three orthogonal antennas and a bottom sensor of three orthogonal antennas; a control electronics coupled to the spatial array of antennas, the control electronics receiving signals from the spatial array of antennas, the control electronics including a processor, a memory coupled to the processor that stores data and executable instructions executed by the processor, and an antenna interface coupled to the processor that receives the signals from the spatial array of antennas; wherein an integrated signal processing system is included in the antenna interface and instructions executed by the processor that provides magnitude and phase of signals from the antennas in the spatial array of antennas; and wherein the processor executes instructions to determine a log trigger based on the magnitude and phase of signals from the antennas that initiates a logging event.

In some embodiments, the processor includes instructions to compute the transverse movement and the peak response. In some embodiments, the processor includes instructions to compute the signal current and depth. In some embodiments, the processor includes instructions to calculate a compass. In some embodiments, the processor includes instructions to calculate a transverse offset. In some embodiments, the control electronics includes an inertial measurement unit and further wherein the processor includes instructions to determine a roll angle.

In some embodiments, the instructions to determine the log trigger includes instructions to determine one or more conditions and instructions for logging locate data when the conditions are all met. In some embodiments, the one or more conditions include one or more of GNSS position difference, phase coherence, roll angle, cable direction, vector calculation, and peak detection. In some embodiments, the magnitude and phase of signals from each of the antennas is given by

$$y = x + j \cdot H ( x )$$

where x is the input signal, j=√−1, and H the Hilbert transform of x. In some embodiments, the phase coherence is provided by determining a spatial coherence in each spatial direction, determining a phase derivative in each spatial direction, determining the phase coherence from the spatial coherence and the phase derivative in each spatial direction. In some embodiments, the log trigger is provided as

LOG TRIGGER = (GNSS Position displacement =>
GNSS threshold) AND (Phase
Coherence=TRUE) AND (Roll-Angle=OK)
AND (Cable Direction=OK) AND
(Vector Displacement= OK) AND (Peak Detected=TRUE)

In some embodiments, the one or more conditions can further include one or more of phase torsion, speed of movement, transmitter warning, and signal distortion.

In some embodiments, the logging event stores locate data in a memory device. In some embodiments, the control electronics includes a communications interface coupled to the processor and the logging event stores locate data in a cloud-based webserver.

In accordance with some embodiments of this disclosure, a method of operating a line locator system includes processing signals from each antenna in an array of antennas, the antennas includes a set of three orthogonal antennas forming a top sensor and a set of three orthogonal antennas forming a bottom sensor, to determine magnitude and phase of each of the signals from each antenna; activating a log trigger based on the magnitude and phase; and logging locate data when the log trigger is activated. In accordance with some embodiments, activating the log trigger includes determining a phase coherence condition; determining a roll angle condition; determining a cable direction condition; determining a vector calibration condition; determining a peak detection condition; and where the log trigger is activated where the phase coherence is true and the roll angle is ok and the cable direction is ok and the vector displacement is ok and the peak detected is true. In some embodiments, the method further includes activating the log trigger when a GNSS displacement is above a displacement threshold value. In some embodiments, the phase coherence is provided by determining a spatial coherence in each spatial direction, determining a phase derivative in each spatial direction, and determining the phase coherence from the spatial coherence and the phase derivative in each spatial direction.

These and other embodiments are discussed below with respect to the following figures.

### BRIEF DESCRIPTION OF THE FIGURES

FIGS. 1A, 1B, and 1C illustrate a line locator system on which embodiments according to the current disclosure can be implemented.

FIGS. 1D and 1E illustrate operation of a line locator system according to some embodiments of the present disclosure.

FIGS. 2A and 2B illustrate peak and null determination of cable location.

FIGS. 3A, 3B, 3C, and 3D illustrate a location method using the line locator illustrated in FIG. 1.

FIG. 4 illustrate pitch and roll parameters.

FIGS. 5A and 5B illustrate cable direction angles in the line locator as illustrated in FIG. 1.

FIG. 6 illustrates data logging according to some aspects of the present disclosure.

FIGS. 7A, 7B, and 7C illustrate phase alignment between antennas in the line locator illustrated in FIG. 1.

FIGS. 8A and 8B illustrate distortion in location using the line locator illustrated in FIG. 1.

FIG. 9 illustrates a digital differentiator used in the line locator illustrated in FIG. 1.

FIG. 10 illustrates a central difference differentiator used in the line locator illustrated in FIG. 1.

FIGS. 11A and 11B illustrate good and bad angle alignment in the line locator as illustrated in FIG. 1.

FIGS. 12A and 12B show acceptable and unacceptable offset displacements in the line locator as illustrated in FIG. 1.

FIG. 13 illustrates a normalized peak response on shallow and deep cables using the line locator as illustrated in FIG. 1.

These figures along with other embodiments are further discussed below.

### DETAILED DESCRIPTION

In the following description, specific details are set forth describing some embodiments of the present invention. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure.

According to some embodiments, a cable locating instrument automatically senses the characteristic behavior associated with tracing the position of a utility such as a buried pipe or cable. Various measurements and derivations are amalgamated into a single trigger event which causes the instrument to create a logging data record.

This description illustrates inventive aspects and embodiments should not be taken as limiting—the claims define the protected invention. Various changes may be made without departing from the spirit and scope of this description and the claims. In some instances, well-known structures and techniques have not been shown or described in detail in order not to obscure the invention.

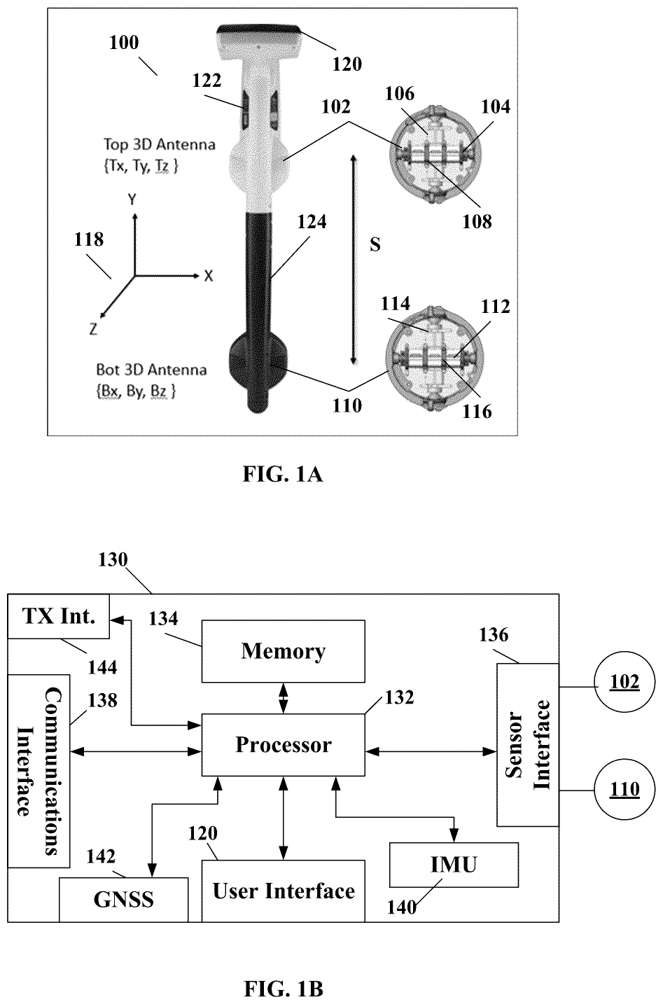

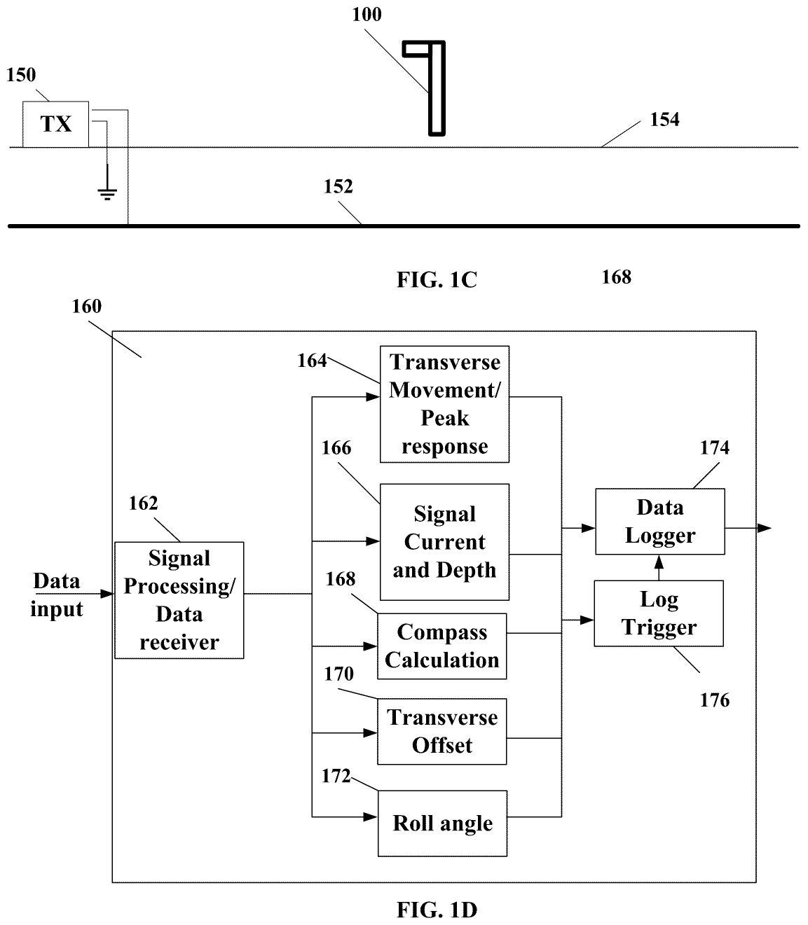

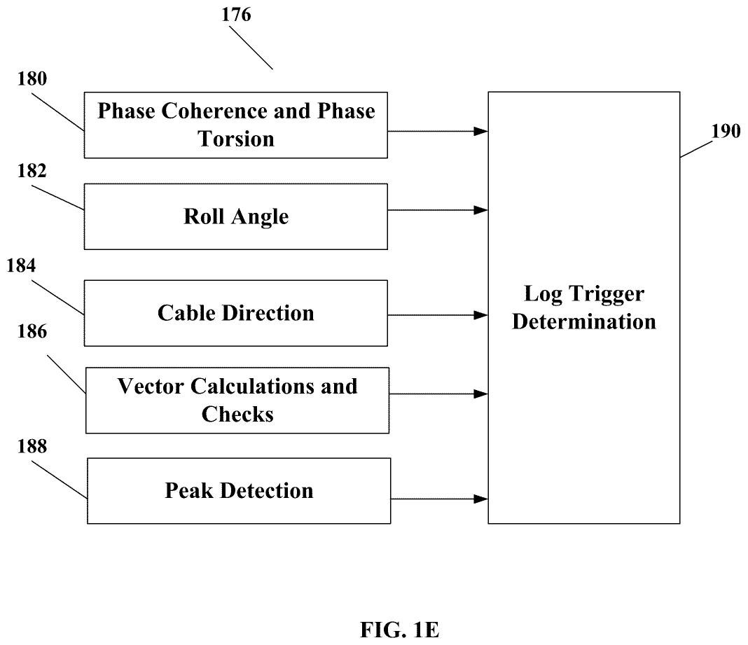

As discussed above, underground utility location is typically performed with a line locator receiver. The line locator includes a series of spatially separated magnetic field detectors capable of measuring magnetic fields that emanate from an underground conductor, otherwise termed an underground line. FIG. 1A illustrates an example system 100 within which embodiments of the present disclosure can be implemented.

Utility Locators comprising a Signal Source (Transmitter) and a Cable Locator (Receiver) are well known and used within industry sectors who own and manage buried assets. The principle of coupling an alternating current directly on to a utility allows both pinpoint locating and depth measurements to be made. In the simplest applications sinusoidal signals are used to allow phase sensitive measurements of the resulting magnetic field. Modern Cable locators have an array of spaced apart antennas (typically between 2 and 6) and use narrow-bandwidth detection algorithms to derive directional information from the correlation of the measured signals to the known geometrical shape of a magnetic field which exists around a buried conductor.

FIG. 1A illustrates a locator system 100 according to some embodiments of the present disclosure. As illustrated in FIG. 1A, locator system 100 includes a top portion 122 and a wand 124 attached to the top portion 122. A user interface 120 can be incorporated in top portion 122. As is further shown, two sensors 102 and 110 are positioned in wand 124 and separated by a distance S along wand 124. As further illustrated by reference frame 118, a Y direction can be considered along wand 124 while the Z direction and the Y direction are orthogonal to the Y direction.

As illustrated in FIG. 1A, in some embodiments each of sensors 102 and 110 include three orthogonally oriented magnetic field sensors. Sensor 102, the top sensor, includes magnetic field sensors 104, 106, and 108 that are oriented along the X direction, the Y direction, and the Z direction, respectively, to measure the magnetic fields Tₓ along the X direction, T_{y} along the Y direction, and T_{z} along the Z direction. Similarly, sensor 110, the bottom sensor, includes magnetic field sensors 112, 114, and 116 that are oriented along the X direction, the Y direction, and the Z direction, respectively, to measure the magnetic fields Bₓ along the X direction, B_{y} along the Y direction, and B_{z} along the Z direction. Sensors 102 and 110 are separated by a distance S along the Y direction.

FIG. 1B further illustrates aspects of locator system 100 according to some embodiments. FIG. 1B illustrates a block diagram of control electronics 130 that may, for example, be incorporated into top portion 122 of locate system 100. As illustrated in FIG. 1B, control electronics 130 includes a processor 132 coupled to a memory 134. Memory 134 can be any combination of volatile memory, non-volatile memory, or data storage system that is sufficiently sized to hold data and instructions to execute the functions according to the disclosure. In particular, as is further discussed below, memory 134 can include a mass storage device that can receive and store logged locate data. Processor 132 can be any combination of microprocessors, microcomputers, application specific integrated circuits (ASICs), or other digital electronics that can execute instructions stored in memory 134 and process data stored in memory 134 as described below.

As is further illustrated in FIG. 1B, processor 132 is coupled to sensor interface 136. Sensor interface 136 is coupled to sensors 102 and 110 to receive signals related to the magnetic fields Tx, Ty, Tz, Bx, By, and Bz, digitize those signals, and provide that data to processor 132 for further processing. Additionally, control electronics 130 can include an inertial measurement unit (IMU) 140 coupled to processor 132 that monitors motion of locate system 100 and may include accelerometers and gyroscopes that measure linear acceleration in multiple directions as well as angular acceleration.

Additionally, processor 132 is coupled to user interface 120, which as discussed above is incorporated into top portion 122. User interface 120 can present locate data to an operator of locate system 100 and receive input from user interface 120. As such, user interface 120 may include various displays, touchscreens, physical buttons, audio, indicators, or other interface devices.

Additionally, processor 132 can interface with a communications interface 138. Communications interface 138 can include both wireless and wired communications standards such as WiFi, cell service, Bluetooth, or other interfaces. In particular, in some embodiments locate system 100 can communicate with cloud-based services such as data storage and data processing through communications interface 138. Control electronics 130 can also include a TX interface 144, which may be part of communications interface 138. TX interface 144 provides communications, for example wireless communications, to a local transmitter that is attached to the underground line to provide current through the underground line.

Further, control electronics 130 can includes a Global Navigation Satellite System (GNSS) receiver system 142. GNSS system 142 can be any global positioning system, including the Global Positioning System (GPS), Real-Time Kinematics (RTK) system, or other geographical positioning system that provides the location of locate system 100.

An example of locate system 100 that can be used to implement embodiments of the present disclosure is the vLoc3-Pro series locators, produced by Vivax-Metrotech, Inc. In the vLoc3-Pro locators, sensors 102 and 110 can be formed by 6 antennas that are grouped in 2 sets of mutually orthogonal sensors as shown in FIG. 1A. In the vLoc3-Pro locators, sensors 102 and 110 have a spacing S of about 37 cm. This 6-channel arrangement yields a capable platform for performing vector geometry on a real 3D magnetic field.

FIG. 1C illustrates operation of locate system 100 according to some embodiments of the present disclosure. As shown in FIG. 1C, line locator system 100 is positioned near ground 154 over 152. As discussed below, line locator system 100 can be laterally displaced with respect to underground line 152. A transmitter 150 can be coupled to provide current to underground line 152. As discussed above, transmitter 150 and line locator system 100 can be in communication so that locator system 100 can receive data from transmitter 150. As further discussed below, line locator system 100 can further be in communications with cloud-based services and to log locate data from line locator system 100 and transmitter 150.

### Peak and Null Response Locating

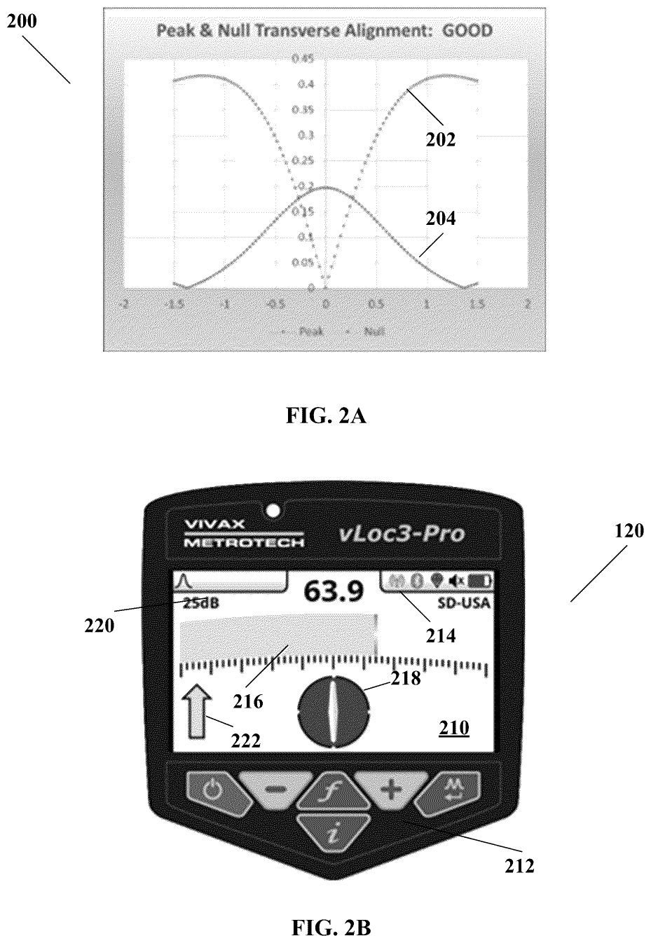

Peak and null response indications inform the traditional practice of cable locating. A twin differential response is the most used antenna configuration. Simply, the magnitude signals received at sensor interface 136 from the bottom horizontal antenna 116 (Bx) of sensor 110 and the top horizontal antenna 108 (Tx) from sensor 102 are subtracted and normalized. This function produces a peak response which corresponds to the cable position when locate system 100 is positioned directly above the underground line to be located. The differential nature of this function improves the common mode rejection when compared to a single antenna measurement. The null response is the normalized response from the vertical orientated signals which experience a phase reversal at the cable position. The null locate can be derived from the single bottom vertical antenna 115 {By} or from a phase sensitive derivation from the {By, Ty} pair from the bottom vertical antenna 115 and the top vertical antenna 106. Peak and null responses are illustrated in FIG. 2A and an example instrument display of user interface 120 illustrate underground line location is illustrated in FIG. 2B.

FIG. 2A illustrates a graph 200 illustrating a null curve 202 and a peak curve 204. As illustrated, in the ideal conditions illustrated the minimum of null curve 202 corresponds with the maximum of the peak curve 204, both of which indicate the position of the corresponding underground utility relative to line locate system 100.

FIG. 2B illustrates an example of user interface 120. As is illustrated in FIG. 2B, user interface 120 may include user input buttons 212 and an example display 210. User input buttons 212 allow a user of locate system 100 to control its operation, including the functioning of display 210. The example of display 210 is consistent with use of graph 200 for locating an underground line. In particular, display 210 includes a status indicator 214 that shows various parameters such as battery state, sound levels, GPS positioning, Bluetooth status, etc. Further, display 210 includes a signal indicator 216, both a graphical representation and a numeric representation is illustrated, which can help identify the peak of peak curve 204. In some examples, a compass 218 can be included that indicates the direction of the underground line. Further, a gain 220 can be indicated. Other displays that assist a user to position line locate system 100 over a target underground line.

Other more elaborate antenna configurations may also be used. For example, a twin horizontal peak response can be formulated from the vector summations:

$$\vec{Omn ι} = \sqrt{( {Bx}^{2} + {By}^{2} )} - \sqrt{( {Tx}^{2} + {Ty}^{2} )}$$

Such responses have the advantage of making the locating operation independent of the relative heading of the locator to the direction of the cable. It is also more accurate in most real-life scenarios as compared to the single axis equivalent {Bx, Tx}.

### Vector Locate

Referring again to FIG. 1A, the magnetic field measurements {Bx, Tx, By, Ty} use sensor coils wound on a ferrite core with high magnetic permeability. The orthogonal measurements {Bz, Tz} use an air cored sensor which encapsulates the overall enclosure. The combined measurements result in a true description of the magnetic vector. For example, the magnitude of the magnetic field vector from the bottom sensor 110|B| is given by

$$\vert \vec{B} \vert = \sqrt{{Bx}^{2} + {By}^{2} + {Bz}^{2}}$$

while the magnitude of the top magnetic field vector |T| is given by

$$\vert \vec{T} \vert = \sqrt{{Tx}^{2} + {Ty}^{2} + {Tz}^{2}}$$

The vector directions come from the phase sensitive measurements of the component measurements. Consequently, the magnetic field vector direction at bottom sensor 110 can be given by

$$\vec{Bx} = [ \frac{Bx}{\sqrt{{Bx}^{2} + {By}^{2} + {Bz}^{2}}} ] \cdot \vec{x} \vec{By} = [ \frac{By}{\sqrt{{Bx}^{2} + {By}^{2} + {Bz}^{2}}} ] \cdot \vec{y} \vec{Bz} = [ \frac{Bz}{\sqrt{{Bx}^{2} + {By}^{2} + {Bz}^{2}}} ] \cdot \vec{z}$$

while the top magnetic field vector direction is given by

$$\vec{Tx} = [ \frac{Tx}{\sqrt{{Tx}^{2} + {Ty}^{2} + {z}^{2}}} ] \cdot \vec{x} \vec{Ty} = [ \frac{Ty}{\sqrt{{Tx}^{2} + {Ty}^{2} + {Tz}^{2}}} ] \cdot \vec{y} \vec{Tz} = [ \frac{Tz}{\sqrt{{Tx}^{2} + {Ty}^{2} + {Tz}^{2}}} ] \cdot \vec{z}$$

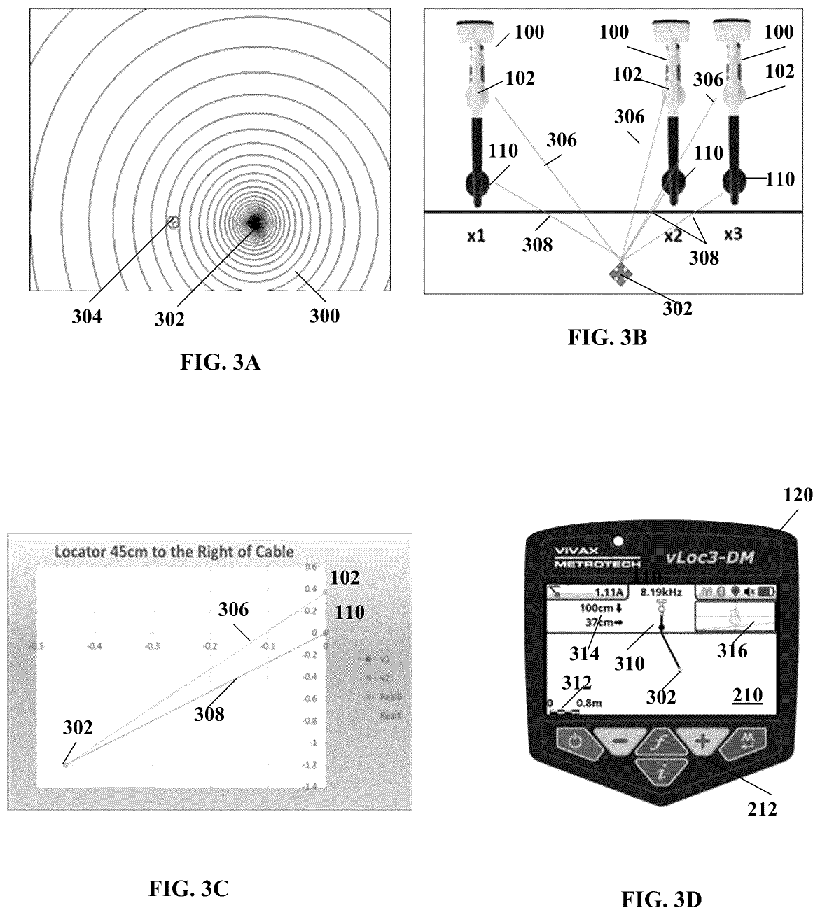

The computations listed allow consideration of a set of orthonormal vectors which emanate from the current element flowing in the buried conductor (utility). In the example of a current flowing in one buried conductor the magnetic field shape is a pure radial field with a 1/r dependency. In these circumstances the orthonormal vectors from the Top and Bottom antenna sets intersect at a point. Vivax-Metrotech has a proprietary algorithm which computes the best intersection of the orthonormal vectors when the conditions are not perfect. The algorithm delivers a true relative location in real-time and is independent of human interpretation. Cable depth and current can also be calculated including when the locator is positioned at an offset position. The algorithm is not mutually exclusive to other locating methods—it can work in parallel with other modes—for example the traditional peak and null responses. FIGS. 3A through 3D illustrate location using depth and current.

FIG. 3A, for example, illustrates the magnetic fields 300 generated by a current carrying utility line 302. As is illustrated, the magnitude of the magnetic field decreases with a as 1/r dependency from underground line 302 and, in an ideal situation, the magnetic field vector is circular around the center of utility line 302. Consequently, from a random position 304, the direction to underground line 302 can be determined by measuring the top and bottom field directions \vec{T} and \vec{B} along with magnitudes |\vec{T}| and |\vec{B}| and determining orthogonal vectors 306 and 308 from the top and bottom sensors 102 and 110 that will intersect at underground line 302.

FIG. 3B illustrates positioning locate system 100 at three positions, position x1, x2, and x3, over utility line 302. Data from any number of positions can be used. As illustrated in FIG. 3B, at each of the positions, the top and bottom field directions \vec{T} and \vec{B} along with magnitudes |\vec{T}| and |\vec{B}| are determined from the fields measured at top sensors 102 and bottom sensor 110 and orthogonal vectors 306 and 308 are determined. Better position estimation of the location of underline utility 302 is obtained based on orthogonal vectors 306 and 308 from multiple positions (x1, x2, and x3). The accuracy can be improved with each additional position of measurement. FIG. 3C further illustrates graphically the use of orthogonal vectors 306 and 308 from a single position to locate the position of underground line 302.

FIG. 3D illustrates an example display 210 of user interface 120 that represents location of underground utility 302 according to some embodiments. As illustrated in FIG. 3D, graphic 310 that illustrates the locate system 100 relative to underground line 302. Details 314 illustrate the distances of underground line 302 from locator system 100. Further, a scale 312 can be displayed. Further, a ground map 316 illustrating the relationship between line locator 100 and underground line 302 can be displayed.

### Inertial Measurements

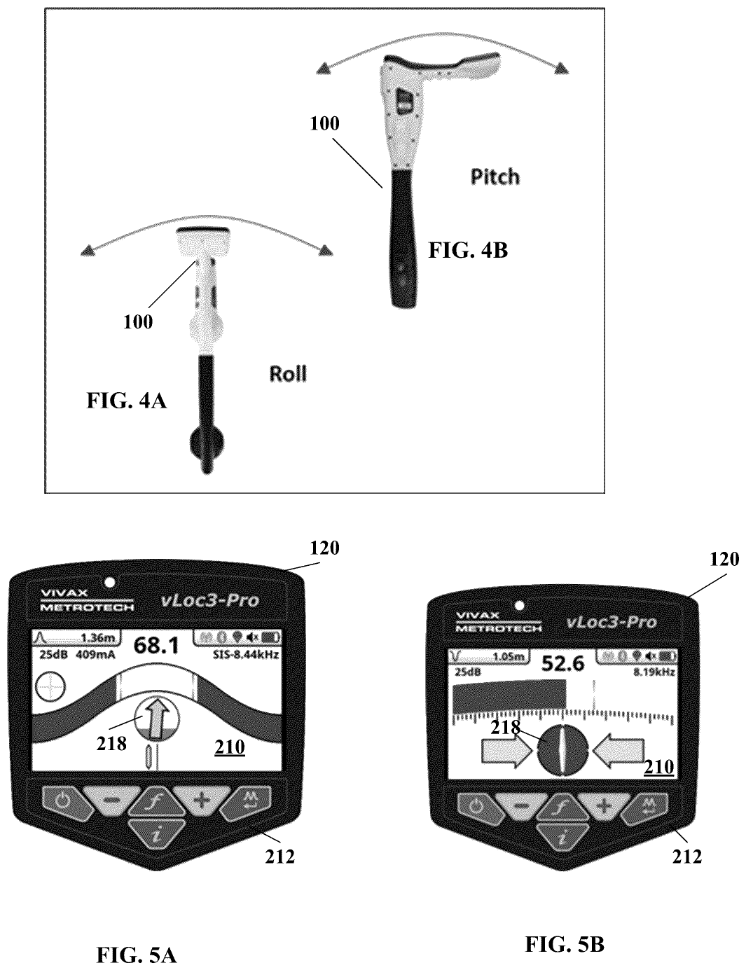

As shown in FIGS. 1A and 1B, line locator system 100 can be equipped with electronic Inertial Measurement Unit (IMU) 140. As discussed above, IMU 140 includes combinations of accelerometers and gyroscopes. Typically, the accelerometer delivers the measured linear acceleration on 3-orthogonal axes and the gyroscope yields angular velocity measurements with respect to the same axes. FIG. 4A, for example, illustrates a pitch parameter that is monitored by one of the gyroscopes and FIG. 4B illustrates a roll parameters monitored by another one of the gyroscopes of IMU 140.

The data bandwidth for the inertial measurements made in IMU 140 can be compatible with the calculations of the magnetic locate vectors as defined above with respect to peak and null response locating and vector locating, typically from 20 Hz to 100 Hz dependent on the operating mode and user preferences. The vLoc3-Pro series of locators, for example, adjust various measurements for non-zero pitch—such compensation is good only for small angles (e.g., within a pitch of 20°).

### Cable Direction Measurement

The antenna pairs {Bx, Bz} (antennas 112 and 116 of sensor 110) and {Tx, Tz} (antennas 104 and 108 of sensor 102) measure the alternating magnetic field in the horizontal plane (x-z plane as shown in coordinate system 118). When the locator is in perfect alignment with the direction of the cable, the Bz and Tz antennas (antennas 116 and 108) carry no signal information. When, however, the locator's axes 118 are at a finite angle with respect to the direction of underground locator 302, it follows that the cable direction angles in the X-Z plane can be derived from simple trigonometry:

$${θ}_{Bott} = {tan}^{- 1} \vec{\frac{\vert Bx \vert}{\vert \vec{Bz} \vert}} and {θ}_{Top} = {tan}^{- 1} \vec{\frac{\vert Tx \vert}{\vert \vec{Tz} \vert}}$$

The cable direction angle is referred to as the “compass” in common parlance, as is illustrated as compass 218 shown in FIG. 2B. The angle presented can typically be a weighted sum of the top and bottom measurements, with the bottom sensor 110 being 3 parts to 1 part of the top sensor 102 the dominant contribution. The cable direction is presented to the user interface as a rotating arrow which behaves like a compass as is illustrated in FIG. 2B as well as in FIGS. 5A and 5B, the only difference being the measurement is the relative cable direction, not magnetic north.

FIGS. 5A and 5B illustrates further examples of displays 210 of user interface 120. The example displays 210 shown in FIGS. 5A and 5B. Each of the example displays 210 of FIGS. 5A and 5B illustrate a compass 218 as described above.

### Data Acquisition and Logging

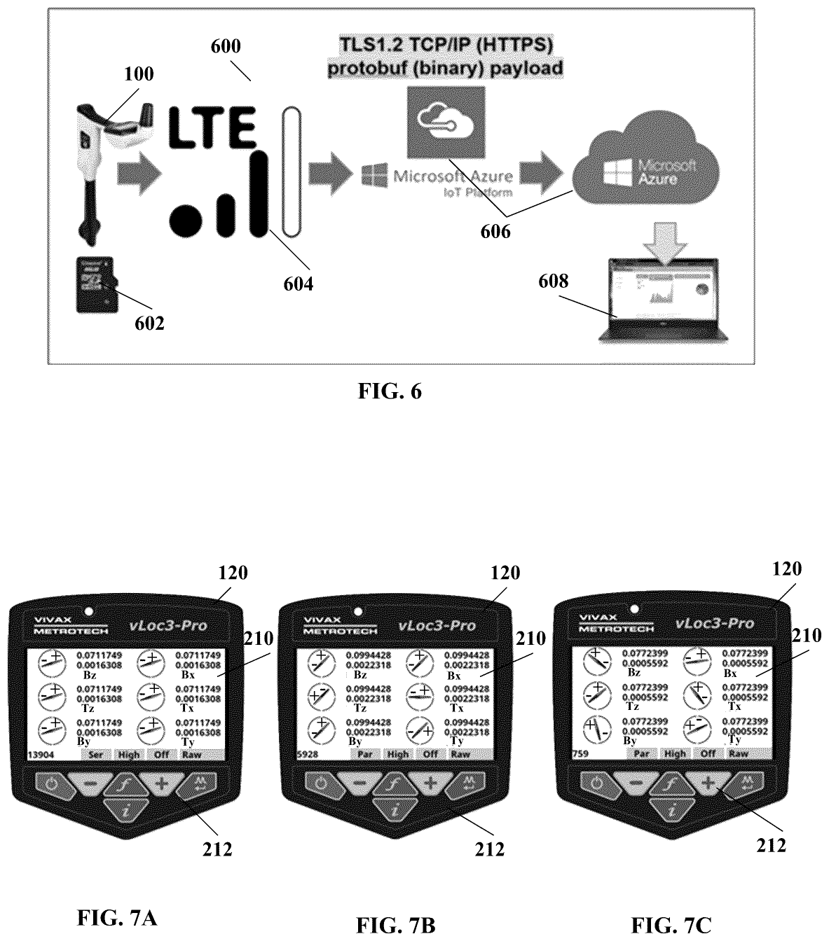

FIG. 6 illustrates logging of the data acquired by locate receiver 100 according to some embodiments. As shown in FIG. 6, line locate system 100 communicates with cloud services 606, for example using communications interface 138 as illustrated in FIG. 1B.

Communications interface 138 can use any interface standard 604 to communicate with cloud-based services 606. As shown in FIG. 6, interface standard 604 can be a cellular standard such as LTE.

In some embodiments, an external storage card 602 may be included in line locator system 100. Storage card 602, for example, can be a removable memory device that can be part of memory 134 shown in FIG. 1B. Storage card 602 can be used to store a locator log such as that also sent to cloud-based services 606. As discussed above, storage card 602 is a mass storage device that can be part of memory 134 as shown in FIG. 1B.

Cloud-based services can be any service that stores logged data and allows the data to be analyzed. For example, as shown in FIG. 6, cloud-based services can be the Microsoft Azure IoT platform. Additionally, a remote user 608 can access the cloud-based services 606. Remote user 608 can access the data, analyze the data, and otherwise work with the data logged from locate system 100 and transferred to cloud-based services 606.

Data logging can be triggered by several mechanisms. For example, data logging events can be triggered by the user, time interval sampling, data changes, or other actions. The original method, and still the most widely practiced way to initiate a data log record, is user initiation of the log points. Typically, the operator of locate system 100 can use the peak and null response bar-graph screens (with any permutation of antennas contributing) and note the position of the maximum signal within a transverse sweep. Locator System 100 would then be positioned on the maximum position where a key is pressed causing the locator to store a log record.

In some embodiments, Time Sampled Data Logging can be used in underground locate system 100. Time sample data refers to on-the-fly measurements of all relevant data at a fixed sampling period. Typical sampling frequencies can be anything from 0.1 Hz to 10 Hz. A disadvantage of a fixed rate sampling system is it generates verbose and tedious data relative to the real information content. Studies show that at a 10 Hz sampling rate only between 1% and 2% of the data records would be useful for constructing a digital map. Claims have been made that Artificial Intelligence can and would be able to process and filter “everything”-resulting in a perfect underground utility map. However, there is no evidence that AI processing would result in a better underground utility map.

In some embodiments, data logging can be triggered by a Change Sensitive Data Sampling. This triggering mechanism is a more efficient method for triggering a data log record. Any change to an applicable state variable can cause a log trigger. Such changes are driven from (i) GNSS measurements; (ii) user actions; (iii) measured changes in the magnetic field (iv); inertial sensing via the IMU 140.

GNSS events determined in GNSS 142 which can trigger a log record can include GNSS Position, GNSS Status, and GNSS Quality Indication. A trigger even can occur using the GNSS position when locate receiver 100 has moved a distance greater than a threshold distance. An example threshold distance can be anything from 20 cm to 5 m. The GNSS position trigger can be in any direction relative to the previous sampled point.

In some cases, a GNSS status change can trigger a logging event. Any change in the status reported from the GNSS interface 142 causes a log to be created. An example of such a triggering event can be the GNSS Source changing from internal to external.

GNSS quality indications can also be used to trigger a logging event. In particular, a change in the positional accuracy can be used. Positional accuracy can include SPS, DGPS, RTK Float, RTK Fix. SPS refers to standard precision (5 m accurate). DGPS can be between 2 m-60 cm accurate. RTK Float is harder to quantify, always inferior to RTK Full, but can be within 10 cm. RTK Fix can have a 2 cm accuracy.

In some cases, user actions via keypad and screen can be used as a trigger. These actions can, for example, include changing locate screen, changing the bar-graph gain, selecting a new locate frequency, changing the antenna configuration, changing the live warning status, or other user-initiated actions.

In some cases, environmental parameters can be used to trigger a logging event. For example, some environmental parameters can determine detection of an overhead signal, detection of a shallow signal, or detection of a signal overload warning,

Inertial Parameters can also be used to trigger logging events. In particular, when locator system 100 has a position outside acceptable limits. Roll angle, for example exceeding a threshold value (e.g., ˜24°). Similarly, pitch angle exceeding a threshold value which can be dependent on the locating mode and physical mechanics.

Problems with Current Practice

Existing data logs and trigger-log mechanisms as described above, however, are lacking in several areas. For example, user-initiated logging is considered too slow for some operators in the contract locate industry. In some cases the work practice is not to stop moving during the locate session. Assessing whether the locator is positioned directly above the cable may take between 10 and 30 seconds and this is not cost effective given the number of survey points required to obtain sufficient data logging for an underground utility mapping. Further, when using peak and null responses via the bar-graph as discussed above, the positioning determination is subject to human error and can be difficult when the cable is deep (≥1.5 m) because the signal gradient with respect to transverse movement is small. Further problems in actual location arise if there are substantial common mode signals present.

Cable locators with less than 6 antennas encounter problems when the cable position is inaccessible from the surface—typically caused by an obstruction. To create a meaningful data log record in such conditions requires the transverse offset measurement which is intrinsic to the vector algorithm. Additionally, human interpretation is very difficult when there is more than one cable influencing the locator.

Additionally, currently available locators do not attempt to arbitrate whether the instrument is performing a locate task or not. This may sound surprising, but the work practice to date has relied entirely on human judgement—examples being (i) an acceptable signal-to-noise as judged by the bar-graph deflection (ii) stability of left-right arrows (iii) stability of the cable direction indication (compass).

### Solution According to Embodiments of the Present Disclosure

Although in some embodiments of the present disclosure the trigger mechanisms discusse above can be implemented in locate system 100. Further, in accordance with embodiments of the present disclosure, an additional trigger mechanism is created whereby a buffer of applicable locate information is stored in a mass storage device 602 as illustrated in FIG. 6 and is optionally sent to a Cloud Webserver and database. Embodiments include monitoring of the instrument's measurements in real-time to create a log-trigger. The trigger event can include several independent conditions to be true, this includes time and spatial assessment of the magnetic signals from 6-antennas and assessment of the instrument's ballistics and relative orientation.

Data log entries that can be stored on storage device 602 comprise a comprehensive set of magnetic vectors (magnitude and phase), geometric derivations (cable direction, cable depth, transverse offset), use-case data, GNSS outputs (latitude, longitude, altitude) and a host of other miscellaneous data fields. Such data sets are already used within the locating industry and are created according to embodiments of the present disclosure as a result of the trigger event described below.

Embodiments of the present disclosure use a number of characteristics of the line locator system 100 illustrated in FIGS. 1A through 1C. In particular, line locator system 100 includes sensors 102 and 110 with six antennas (antennas 104, 106, and 108 in sensor 102 and antennas 112, 114, and 116 in sensor 110). In particular, sensor 102 includes one set of mutually orthogonal antennas along the x, y, and z directions as shown by coordinate system 118. Similarly, sensor 110 includes a second set of mutually orthogonal antennas along the x, y, and z directions as shown by coordinate system 118.

Further, in embodiments of the present disclosure, transmitter 150 provides a signal source that is ideally a transconductance amplifier (commonly referred to as a transmitter) which can energize an underground utility 152 with a sinusoidal current. Transmitter 150 provides high fidelity output, for example with a phase jitter not exceeding 50 ps, and a total harmonic distortion not exceeding 0.2%.

FIG. 1D illustrates some example systems 160 that may include instructions stored in memory 134 and executed by processor 132 as part of control electronics 130. As illustrated in FIG. 1B, processor 132 receives data inputs from sensor interface 136, IMU 140, GNSS 142, TX interface 144, communications interface 138, and user interface 120. Further, algorithms for providing an automated logging trigger 172 is also provided. As shown in FIG. 1D, data from sensors 102 and 110, IMU 140, GNSS 142, and transmitter 150 is received by signal processing block and data receiver 162 and the results provided to transverse movement/peak response block 164, signal current and depth 166, compass calculation 168, transverse offset block 170, and roll angle 172. The resulting data is then provided to logging trigger 172 and data logger 170.

In embodiments of the present disclosure, line locator system 100 includes a signal processing system and data receiver system 162 as illustrated in FIG. 1D. Signal processing system and data receiver system 162 delivers magnitude and phase of the magnetic fields measured in sensors 102 and 104 as a complex number for each antenna and computed within a narrow bandwidth (typically 5 Hz). The signal processing system can be provided in sensor interface 136, performed by programming instructions stored in memory 134 by processor 132, or performed in a combination of circuitry in sensor interface 136 and executable instruction in memory 134 and processor 132.

As shown in FIG. 1D, embodiments of the present disclosure include a transverse offset block 172. Transverse offset block 172 includes executable instructions stored in memory 134 and executed on processor 132 for calculating the transverse offset of locator system 100 with respect to underground utility 152. The transverse offset block 166 utilizes a signing convention, for example offset to the “left” of underground utility 152 with respect to the Z-direction shown by coordinate system 118 is negative, offsets to the right of underground utility 152 are positive. The term left and right is determined by the orientation of underground utility 100.

As is further illustrated in FIG. 1D, embodiments of the present disclosure further includes Signal Current and Depth block 166 that includes executable instructions stored in memory 134 and executed on processor 132 for computing the signal current and depth (including when locator system 100 is in the offset position). Further, as shown in FIG. 1D, embodiments of the present disclosure includes a compass calculation block 168 that includes executable instructions stored in memory 134 and executed on processor 132 for computing the relative cable direction—the “compass” 218 as described above. As is further illustrated in FIG. 1D, embodiments of the present disclosure also include a transverse offset block 170 with executable instructions stored in memory 134 and executed on processor 132 for monitoring the transverse movement of the locator across the cable position and for detecting the peak response from either a single antenna or a group of antennas of sensors 102 and 110.

Further, as shown in FIG. 1D, embodiments of the present disclosure include a roll-angle block that determines the roll angle of locator system 100 with respect to gravity. In some embodiments, IMU 140 may include a separate leveling system separate from the accelerometers and gyroscopes discussed above to determine the roll, and in some cases pitch, of IMU 140 with respect to gravity. Roll angle block 172 receives the data from the leveling system and includes executable instructions stored in memory 134 and executing on processor 132 for determining the roll angle.

Transverse movement/peak response block 164, signal current and depth block 166, compass calculation block 168, transverse offset block 170, and roll angle block 172 can be executed sequentially in any order or, in some systems, may be performed in parallel. The results of each of these blocks is then input to both logging trigger 176 and data logger 174.

As is further Embodiments of the present disclosure include a data logger 174 operating on locate system 100 as described above. Data logger 174 includes executable instructions stored in memory 134 and executed on processor 132 that logs data into mass storage device 602 incorporated into memory 134 as described above. Further, where locate system 100 is connected to a Cloud Webserver 606 as illustrated in FIG. 6 (which, as described below, is not essential), data logger 174 can log data directly to Cloud Webserver 606. Connectivity to webserver 606 through communications interface 138 can be by WiFi, Cellular Network and Bluetooth using VMMAP (smart device application) or any other fashion. Such a data logging system 600 is illustrated in FIG. 6.

As is further illustrated in FIG. 1D, data logger 174 is triggered to form a data log when triggered by Log Trigger 176. In accordance with embodiments of the present disclosure, Log Trigger 176 is a ‘true locate’ log-trigger, without human intervention and judgement errors, and not just a trigger formed by the passage of time. The true-locate trigger is formed from combinational logic using derivations of data and calculations as described below and described in FIG. 1E.

Log Trigger block 176 is further described with FIG. 1E. As is illustrated in FIG. 1E, Log Trigger block 176 includes a phase coherence and phase torsion determination 180, a roll angle determination 182, a cable direction determination 184, a vector calculation and check determination 186, peak detection 188, which all lead to a log trigger determination 190.

### Phase Coherence and Phase Torsion 180

Phase Coherence and Phase Torsion determination 180 incorporates the concept of quantifying phase coherence and phase torsion on a cable locating instrument such as locate system 100 according to some embodiments of the present disclosure. Pure phase coherence exists when two (2) waves have the same frequency. Embodiments of the present disclosure in phase coherence and phase torsion 180 of log trigger 176 exploits partial coherence that is made possible when there is close frequency alignment between transmitter 150 and locate receiver system 100. Exact frequency alignment is not required in locate system 100 as the output signals are resolved into their analytic functions:

$$y = x + j \cdot H ( x )$$

where x is the input signal, j=√−1, and H the Hilbert transform of x. Each antenna signal from each of sensors 102 and 110 is resolved into a signal magnitude and phase as computed in a narrow bandwidth (typically 5 Hz) using the above analytic function and defines a locate vector for each of the antennas. Several situations are illustrated in FIGS. 7A through 7C, where the arrows represent phasors (the phase) and the function y above for each of the antennas 104, 106, and 108 of sensor 102 and antennas 112, 114, and 116 of sensor 110 as shown in FIG. 1. In FIGS. 7A, 7B, and 7C Bz, Bx, By, Tz, Tx, and Ty are illustrated as the locate vectors determined by the above analytic function.

FIG. 7A shows locate vectors derived from all six (6) antennas after locator system 100 has been calibrated. In the example illustrated in FIG. 7A, all six (6) antenna channels are in close phase alignment (within 0.5°), as is illustrated by the displayed phasors. The phasors typically rotate at a rate governed by the clock-time differences between the transmitter and receiver (typically 30 ppm error). Such differences are of no consequence because it is only the relative phase that matters. In FIG. 7B, the {Bz, Tz} antennas are in coherent anti-phase (as shown by the +/− polarization indication in the displayed phasors), {By, Ty} are in coherent phase and {Bx, Tx} demonstrate a phase torsion as is discussed further below. In FIG. 7C there is no coherence on any axis as indicated by the differently directed phasor arrows.

Embodiments of the present disclosure quantifies phase coherence into 3 related calculations: spatial coherence, phase torsion, and time derivative coherence. Spatial Coherence is determined where the relative phase of the antenna pairs {Bz, Tz}, {By, Ty} and {Bx, Tx} are compared and checked to be within an acceptable tolerance of each other. The acceptable tolerance, or threshold value, can be, for example, ±8°. However, any tolerance threshold value can be used. Spatial coherence can also be true when the antenna pairs ({Bz, Tz}, {By, Ty} and {Bx, Tx}) are in anti-phase (typically 180°±8°). The tolerance threshold is set by the sensor coil inductance and self-capacitance. Assuming a 5% uncertainty, the phase tolerance equates to 0.05 degree per kHz.

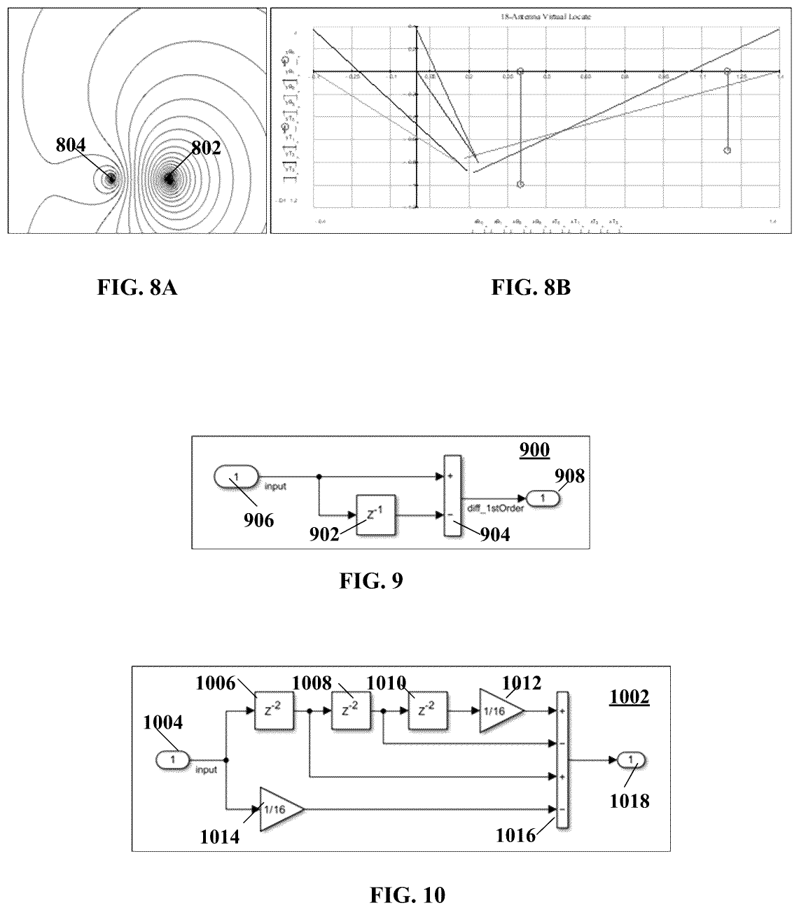

Phase torsion, as illustrated in FIG. 7B, exists when there is a phase difference greater than the coherence threshold on any pair of antennas ({Bz, Tz}, {By, Ty} and {Bx, Tx}) on the same axis. The torsion is also measured with respect to in-phase and anti-phase measurements. A torsion which exceeds the tolerance band is an indicator of signal distortion—present when there is a secondary signal influencing the locator. The most likely cause of phase torsion, as illustrated in FIG. 8A, is when the transmitter signal coupled to a first conductor 802 is also coupled on to another adjacent conductor 804 causing secondary induction. The secondary signal is always phase shifted from the source carrier and will typically rotate the phasor on one antenna with respect to its counterpart antenna on the same axis. In these circumstances the vector measurements will not coincide exactly which is another indicator of signal distortion, however this measurement is slower and does not reveal which axis the distortion is affecting. FIG. 8A illustrate this example of phase torsion while FIG. 8B illustrate a vector representation of the locate from three locations.

Time derivative coherence is the third type of phase coherence. Phase coherence can also be arbitrated to be good if the magnitude of the first derivative of phase is less than an acceptable tolerance threshold (typically equivalent to 3 Hz, although other values can be used). Time derivative coherence is also computed on each antenna axis separately. A phase derivative is calculated using integer mathematics so that the natural wrap-around of a phase angle at 360° is mapped to the integer overflow (either 16- or 32-bits). At that point, the derivative may be calculated using any standard digital differentiator 900 such as that illustrated in FIG. 9. As shown in FIG. 9, digital differentiator 900 includes a delay 902 and adder 904 such that the delay signal from delay 902 is subtracted from the current input signal 906 to provide the first order difference 908.

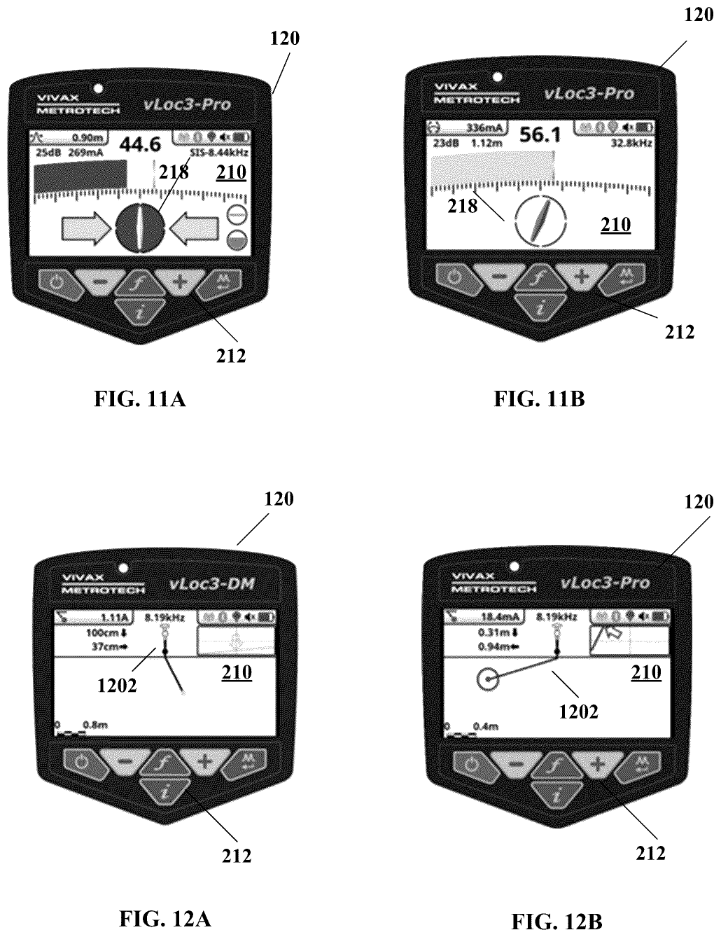

However, experiments and testing have shown superior performance can be achieved using a central difference differentiator 1002 such as that illustrated in FIG. 10. As illustrated in FIG. 10, the input signal 1004 is input to a series array of time delays 1006, 1008, 1010, each of which delay by two time cycles. The output from time delay 1010 is input to a 1/16 amplifier 1012 and then to adder 1016. The input is also input to 1/16 amplifier 1014, the output of which is input to adder 1016. Adder 1016 also receives input from time delay 1006 and time delay 1008 and operates such that the output of adder 1016 is the signal output from amplifier 1012 minus the output signal from delay 1008 plus the output signal from delay 1006 minus the output signal from amplifier 1014. Difference differentiator 1002 reduces relative high frequency noise and is well suited to integer mathematics as the gain multipliers 1012 and 1014 are the equivalent of arithmetic right shifts of 4 bits. The tolerance threshold for the phase derivatives is again set by the frequency discrepancy of the transmitter and receiver combined.

In accordance with embodiments of the present disclosure, the overall assessment of coherence Boolean logic can be determined. With regard to individual axis from antenna pairs ({Bz, Tz}, {By, Ty} and {Bx, Tx}) for each individual axis can be defined as follows:

```
      (bool) Phase Coherence X = (spatial coherence X < threshold A ) AND ( phase
      derivative X < threshold B )
      (bool) Phase Coherence Y = (spatial coherence Y < threshold A ) AND ( phase
      derivative Y < threshold B )
      (bool) Phase Coherence Z = (spatial coherence Z < threshold A ) AND ( phase
      derivative Z < threshold B )
Finally, an overall coherence indicator:
      (bool) Total Coherence = (Phase Coherence X) OR (Phase Coherence Y) OR (Phase
Coherence Z)
```

Consequently, the Total Coherence is TRUE if one or more of Phase Coherence X, Phase Coherence Y, and Phase Coherence Z is TRUE.

As discussed below, the total coherence indicator can be combined with other logical elements to cause the log-trigger event as described below. In some embodiments, the coherence indicator can be constructed from the X-axis component only. This will result in a stricter criterion because the Y and Z contributions are not OR′ ed into the overall result.

### Roll Angle 182

As discussed above, the Roll Angle determination 182 can be computed from an integrated IMU device 140. The IMU computational bandwidth is typically from 10 Hz to 1 kHz. In some embodiments, for example, it is used at 26 Hz but this can be altered by changing the sample rate with the normal trade-off against increased noise. To enable a log-trigger event the roll-angle should be less than 10° in either direction. The threshold is application dependent, it would be less than 7° for a precision survey application but perhaps 15° when configured for the contract locate industry where speed is more important. Consequently, the roll angle should be less than a preset threshold as described here. Consequently, the Roll Angle is considered “OK” when it is within the threshold value for roll angle.

One practical consideration with IMU 140 is to ensure its bandwidth is compatible with the magnetic locate vectors—without this, the outputs are not synchronous and are less suitable for combining into a single trigger event. This problem is overcome with a first order lag compensator on the roll output:

$${y}_{n} = [ \frac{( {k}_{1} z - c 1 )}{( {k}_{1} z - c 2 )} ] {x}_{n}$$

yn is the compensated output, xn is the raw roll signal from IMU 140 and the coefficient sets {k1, c1} and {k2, c2} determine a single poll and a single zero in the transfer function. This filter, executed in block 172 as shown in FIG. 1D, can lag compensate the IMU roll almost perfectly and ensure the locate vectors and the inertial measurements are synchronized to the equivalent referred bandwidth of the locate vectors (3 Hz).

### Cable Direction 184

It is known that the best locate accuracy will be achieved when the locator is aligned with the direction of the cable (i.e., the direction z as shown in FIG. 1 aligns with the underground utility 152). Accordingly, cable direction block 184 computes this deviation. A log-trigger can be enabled if the direction heading from cable direction block 184 is within a threshold value from the z direction (e.g., 0°±7°). Again, the acceptable limits can be configured depending on the particular application. Consequently, the Cable Direction is “OK” if it is within the threshold value for the cable direction. FIGS. 11A and 11B show on display 210 good and bad angle alignment, respectively, as indicated by compasses 218.

### Vector Calculations and Checks 186

It is known that a good quality locate occurs within a small transverse angle about the exact overhead position. Accordingly, the transverse displacement is determined in vector calculations and checks 186. The log trigger can be enabled if the transverse displacement is with a threshold value (e.g., <=45 cm). The threshold value can be any value. This threshold can also be transposed to an angle as the vector algorithm calculates the cable depth. Thus, the Vector Displacement is “OK” if it is within the threshold value for vector displacement. As in all such cases the acceptable offset range is dependent on application. FIGS. 12A and 12B show displays 210 with vector indicators 1202 that illustrate acceptable and unacceptable offset displacements, respectively, for the trigger condition to be true. The log trigger for the vector displacement can also be checked with depth ensuring a negative depth prevents the trigger enable.

### Peak Detection 188

The natural ballistics of the locator in response to a transverse sweep action cause the handle to act as a pivot point and results in a pendulum like motion with some additional transverse displacement superimposed. This swinging action is not recommended for precision locating but is difficult to avoid.

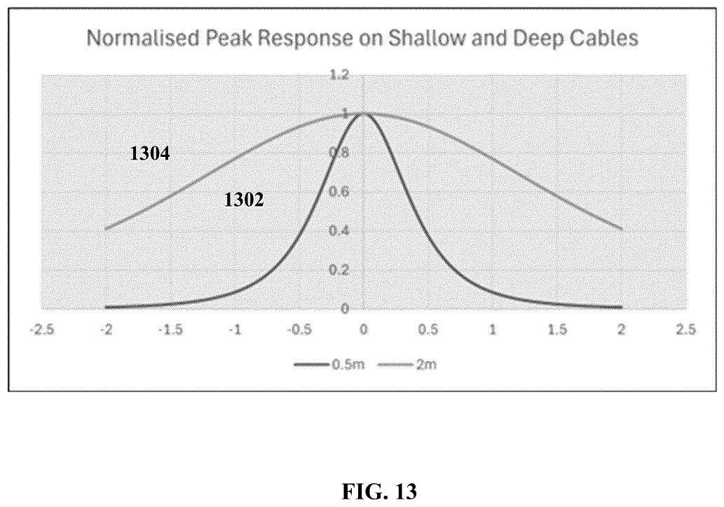

Peak detection 188 assumes the locator system 100 will be using either the omni or twin-horizontal peak detection as described above—although it can be applied to any antenna configuration which gives rise to a maximum or minimum signal when directly over underground cable 156. The peak detection uses a history buffer of bar-graph data and uses this to scan through and find a point where the gradient changes from positive to negative. The displacement variable is also checked using the offset measurement from the vector response. Typically, there will be a section when the gradient is almost zero, and this is more apparent on deeper cables. The problem is further exaggerated in the presence of a common mode signal. FIG. 13 illustrates normalized peak responses on shallow 1302 and deep 1304 cables.

The detection algorithm 188 avoids false peaks by checking the signal gradient continues its passage from positive to negative as the peak position is traversed. A positive detection of a peak response forms a contribution to a log-trigger event.

Therefore, the Peak Detected is “TRUE” when a valid peak has been detected as described above.

### Log Trigger Determination 190

Log Trigger determination 190 is a combination logic that is used to construct a full log-trigger event. The logic may change dependent on the application and customer. A prerequisite of creating a log record may be that the GNSS position has changed by a distance greater than threshold (typically 0.5 m) from the last log trigger.

In log trigger determination 190, one or more of the various logical values described above can logically combined to form the log trigger. Consequently, the Log Trigger can be determined by:

$$LOG TRIGGER = ( Condition 1 ) AND ( Condition 2 ) AND … AND ( Condition N ) .$$

LOG TRIGGER is TRUE, then, when all of the conditions listed are TRUE. At least some of the conditions are those that were particularly discussed above (e.g., GNSS position displacement, Phase coherence, Roll Angle, Cable Direction, Vector Displacement, and Peak Detection).

For middle precision applications, for example, the combined log-trigger can be the logical AND of the contributions discussed above:

```
  LOG TRIGGER = (GNSS Position displacement => GNSS threshold) AND (Phase
Coherence=TRUE) AND (Roll-Angle=OK) AND (Cable Direction=OK) AND (Vector
                Displacement= OK) AND (Peak Detected=TRUE)
```

As illustrated in FIG. 1D, the LOG TRIGGER signal is provided to data logger 174 such that, if TRUE, a data logging event is initiated.

In some cases, the LOG TRIGGER can be determined with more lenient logic conditions, which may be desirable where the results are used to log data as proof of due-diligence—not as part of a ground survey map. A more lenient regime can be created by relaxing the threshold parameters as identified in the constituent measurements or by not using all of the conditions.

Similarly, a more stringent set of conditions can also be used to determine the LOG TRIGGER. Some examples of parameters that can be added to the logical combination described above include requirements on phase torsion, limitation on the speed of movement, determination of any standing warnings, or determining that signal distortion is below a threshold value. These considerations can be included as additional AND functions, and can be determined as indicated below:
(Phase torsion<phase torsion threshold);
(Speed of movement<Speed threshold);
NOT (Transmitter warning active);
(Signal distortion<distortion threshold).
   The phase torsion threshold may, for example, be 20°. The transmitter warnings can include, for example, warnings for shallow depth, overhead cable, excessive swing and signal overload. The signal distortion threshold can be determined by the Vector Algorithm as described above.

In summary, embodiments of the present disclosure can be applied to a cable or pipe locating system 100 having a spatial array of six (6) antennas forming sensors 102 and 110. The antennas in sensors 102 and 110 receive a phase coherent low frequency alternating magnetic field which emanates from a buried conductor 152, where said conductor is energized by a signal generator transmitter 150 and where said field can be measured using an integrated signal processing system in control electronics 130. Further, a data log is generated in response to a log trigger that is generated automatically using multiple conditions. In some embodiments, the antennas are arranged in two (2) sets reflecting sensors 102 and 110, each comprising sensors on three (3) orthogonal axes. In some embodiments, the locate system 100 has an integrated Digital Signal Processor in sensor interface 136 and using processor 132 and can compute signal magnitude and phase in all six (6) channels of the six (6) antennas referred to a narrow bandwidth and configurable from 2 Hz to 20 Hz. In some embodiments, the locating system 100 can construct the analytic signal for each channel. In some embodiments, the phase of each antenna can be checked to have a time derivative not exceeding the proportional frequency error with respect to the transmitter and the detection bandwidth. In some embodiments, the spatial phase coherence of antenna pairs on a single axis can be checked to be within an acceptable band around zero degrees or the same reflected band around 180 degrees. In some embodiments, the spatial phase coherence can be calculated on all 3 antenna axes. In some embodiments, a total axis coherence can be the logical AND of the spatial phase coherences and the phase derivative coherence. In some embodiments, a total locator phase coherence is the logical OR of all the antenna axis contributions. In some embodiments, the total locator phase coherence is derived from the horizontal antenna pair only. In some embodiments, the locating system 100 can compute a relative position of a buried cable, both the cable depth and the transverse offset relative to the magnetic axis of the locate system 100. In some embodiments, the transverse offset can be checked to be within acceptable limits around the cable position and that the computed depth is a positive value. In some embodiments, the locating system 100 can compute the direction heading of the cable relative to its magnetic axis. In some embodiments, the locating system 100 can arbitrate acceptable limits on the cable direction angle. In some embodiments, the locating system is equipped with an integrated IMU 140 and can calculate its roll angle between its magnetic axis and the gravity vector. In some embodiments, the locating system 100 can check that the roll angle is within an acceptable range with respect to gravity. In some embodiments, a peak response can be measured from any antenna configuration within the context of a six (6) antenna system {Bx, By, Bz}, {Tx, Ty, Tz}. In some embodiments, the peak response data from a transverse sweep can be stored in a buffer and an algorithm can find a set of points where the signal gradient changes from positive to negative. In some embodiments, the locate system 100 can arbitrate that a peak response was detected. In some embodiments, combinational logic from the roll sensor, phase coherence, cable direction, and cable offset displacement can be used to determine if a log trigger event can occur. In some embodiments, the locating system has a data logging system and integrated mass storage memory 602. In some embodiments, the locate system 100 has an optional capability of connectivity to a Cloud Webserver 606—either using a Cellular Network, Bluetooth or Wi-Fi. In some embodiments, a log trigger causes a data capture of applicable locate survey data to be stored in a mass storage device 602 and optionally be sent to a Cloud Webserver 606.

Consequently, embodiments of the present disclosure include one or more of the following aspects:

Aspect 1: An underground line locator system includes a spatial array of antennas, the spatial array of antennas detecting an alternating magnetic field emanating from a buried conductor coupled to a transmitter, the spatial array of antennas forming a top sensor of three orthogonal antennas and a bottom sensor of three orthogonal antennas; a control electronics coupled to the spatial array of antennas, the control electronics receiving signals from the spatial array of antennas, the control electronics including a processor, a memory coupled to the processor that stores data and executable instructions executed by the processor, and an antenna interface coupled to the processor that receives the signals from the spatial array of antennas; wherein an integrated signal processing system is included in the antenna interface and instructions executed by the processor that provides magnitude and phase of signals from the antennas in the spatial array of antennas; and wherein the processor executes instructions to determine a log trigger based on the magnitude and phase of signals from the antennas that initiates a logging event.

Aspect 2: The line locator system according to Aspect 1, wherein the processor includes instructions to compute the transverse movement and the peak response.

Aspect 3: The line locator system according to Aspects 1 or 2, wherein the processor includes instructions to compute the signal current and depth.

Aspect 4: The line locator system according to any of Aspects 1-3, wherein the processor includes instructions to calculate a compass.

Aspect 5: The line locator system according to any of Aspects 1-4, wherein the processor includes instructions to calculate a transverse offset.

Aspect 6: The line locator system according to any of Aspects 1-5, wherein the control electronics includes an inertial measurement unit and further wherein the processor includes instructions to determine a roll angle.

Aspect 7: The line locator system according to any of Aspects 1-6, wherein the instructions to determine the log trigger includes instructions to determine one or more conditions and instructions for logging locate data when the conditions are all met.

Aspect 8: The line locator system according to any of Aspects 1-7, wherein the one or more conditions include one or more of GNSS position difference, phase coherence, roll angle, cable direction, vector calculation, and peak detection.

Aspect 9: The line locator system according to any of Aspects 1-8, wherein the magnitude and phase of signals from each of the antennas is given by

$$y = x + j \cdot H ( x )$$

where x is the input signal, j=√−1, and H the Hilbert transform of x.

Aspect 10: The line locator system according to any of Aspects 1-9, wherein the phase coherence is provided by determining a spatial coherence in each spatial direction, determining a phase derivative in each spatial direction, determining the phase coherence from the spatial coherence and the phase derivative in each spatial direction.

Aspect 11: The line locator system according to any of Aspects 1-10, wherein the log trigger is provided as

LOG TRIGGER = (GNSS Position displacement =>
GNSS threshold) AND (Phase
Coherence=TRUE) AND (Roll-Angle=OK)
AND (Cable Direction=OK) AND
(Vector Displacement= OK) AND (Peak Detected=TRUE)

Aspect 12: The line locator system according to any of Aspects 1-11, wherein the one or more conditions can further include one or more of phase torsion, speed of movement, transmitter warning, and signal distortion.

Aspect 13: The line locator system according to any of Aspects 1-12, wherein the logging event stores locate data in a memory device.

Aspect 14: The line locator system according to any of Aspects 1-13, wherein the control electronics includes a communications interface coupled to the processor and the logging event stores locate data in a cloud-based webserver.

Aspect 15: A method of operating a line locator system, including processing signals from each antenna in an array of antennas, the antennas includes a set of three orthogonal antennas forming a top sensor and a set of three orthogonal antennas forming a bottom sensor, to determine magnitude and phase of each of the signals from each antenna; activating a log trigger based on the magnitude and phase; and logging locate data when the log trigger is activated.

Aspect 16: The method of Aspect 15, wherein activating the log trigger includes determining a phase coherence condition; determining a roll angle condition; determining a cable direction condition; determining a vector calibration condition; determining a peak detection condition; and where the log trigger is activated where the phase coherence is true and the roll angle is ok and the cable direction is ok and the vector displacement is ok and the peak detected is true.

Aspect 17: The method of any of Aspects 15-16, further including activating the log trigger when a GNSS displacement is above a displacement threshold value.

Aspect 18: The method of any of aspects 15-18, wherein determining the phase coherence is provided by determining a spatial coherence in each spatial direction, determining a phase derivative in each spatial direction, and determining the phase coherence from the spatial coherence and the phase derivative in each spatial direction.

The above detailed description is provided to illustrate specific embodiments of the present invention and is not intended to be limiting. Numerous variations and modifications within the scope of the present invention are possible. The present invention is set forth in the following claims.

What is claimed is:

1. An underground line locator system, comprising:
a spatial array of antennas, the spatial array of antennas detecting an alternating magnetic field emanating from a buried conductor coupled to a transmitter, the spatial array of antennas forming a top sensor of three orthogonal antennas and a bottom sensor of three orthogonal antennas;
a control electronics coupled to the spatial array of antennas, the control electronics receiving signals from the spatial array of antennas, the control electronics including
a processor,
a memory coupled to the processor that stores data and executable instructions executed by the processor, and
an antenna interface coupled to the processor that receives the signals from the spatial array of antennas;
wherein an integrated signal processing system is included in the antenna interface and instructions executed by the processor that provides magnitude and phase of signals from the antennas in the spatial array of antennas; and
wherein the processor executes instructions to determine a log trigger based on the magnitude and phase of signals from the antennas that initiates a logging event.

2. The line locator system according to claim 1, wherein the processor includes instructions to compute the transverse movement and the peak response.

3. The line locator system according to claim 1, wherein the processor includes instructions to compute the signal current and depth.

4. The line locator system according to claim 1, wherein the processor includes instructions to calculate a compass.

5. The line locator system according to claim 1, wherein the processor includes instructions to calculate a transverse offset.

6. The line locator system according to claim 1, wherein the control electronics includes an inertial measurement unit and further wherein the processor includes instructions to determine a roll angle.

7. The line locator system according to claim 1, wherein the instructions to determine the log trigger includes instructions to determine one or more conditions and instructions for logging locate data when the conditions are all met.

8. The line locator system according to claim 7, wherein the one or more conditions include one or more of GNSS position difference, phase coherence, roll angle, cable direction, vector calculation, and peak detection.

9. The line locator system according to claim 8, wherein the magnitude and phase of signals from each of the antennas is given by
$$y = x + j \cdot H ( x )$$
where x is the input signal, j=√−1, and H the Hilbert transform of x.

10. The line locator system according to claim 9, wherein the phase coherence is provided by determining a spatial coherence in each spatial direction, determining a phase derivative in each spatial direction, determining the phase coherence from the spatial coherence and the phase derivative in each spatial direction.

11. The line locator system according to claim 8, wherein the log trigger is provided as
LOG TRIGGER = (GNSS Position displacement =>
GNSS threshold) AND (Phase
Coherence=TRUE) AND (Roll-Angle=OK)
AND (Cable Direction=OK) AND
(Vector Displacement= OK) AND (Peak Detected=TRUE).

12. The line locator system according to claim 8, wherein the one or more conditions can further include one or more of phase torsion, speed of movement, transmitter warning, and signal distortion.

13. The line locator system according to claim 1, wherein the logging event stores locate data in a memory device.

14. The line locator system according to claim 1, wherein the control electronics includes a communications interface coupled to the processor and the logging event stores locate data in a cloud-based webserver.

15. A method of operating a line locator system, comprising:
processing signals from each antenna in an array of antennas, the antennas includes a set of three orthogonal antennas forming a top sensor and a set of three orthogonal antennas forming a bottom sensor, to determine magnitude and phase of each of the signals from each antenna;
activating a log trigger based on the magnitude and phase; and
logging locate data when the log trigger is activated.

16. The method of claim 15, wherein activating the log trigger includes
determining a phase coherence condition;
determining a roll angle condition;
determining a cable direction condition;
determining a vector calibration condition;
determining a peak detection condition; and
where the log trigger is activated where the phase coherence is true and the roll angle is ok and the cable direction is ok and the vector displacement is ok and the peak detected is true.

17. The method of claim 16, further including activating the log trigger when a GNSS displacement is above a displacement threshold value.

18. The method of claim 16, wherein determining the phase coherence is provided by determining a spatial coherence in each spatial direction, determining a phase derivative in each spatial direction, and determining the phase coherence from the spatial coherence and the phase derivative in each spatial direction.
